(19) United States
(12) Patent Application Publication
(10) Pub. No.: US 2024/0383604 A1
(43) Pub. Date: Nov. 21, 2024

(54) Packaging for use with Uncrewed Aerial Vehicle

(71) Applicant: Wing Aviation LLC, Palo Alto, CA (US)

(72) Inventors: Elizabeth Marshman, San Francisco, CA (US); Evan Twyford, Houston, TX (US); Jasper Lewin, Santa Cruz, CA (US)

(21) Appl. No.: 18/400,530

(22) Filed: Dec. 29, 2023

Related U.S. Application Data
(60) Provisional application No. 63/477,982, filed on Dec. 30, 2022.

(51) Int. Cl. B64D 1/08; B64U 10/20; B64U 101/64

(52) U.S. Cl. CPC B64D 1/08; B64U 10/20; B64U 2101/64

(57) ABSTRACT

A package adapted for use with an uncrewed aerial vehicle (UAV) is provided. The package includes a hanger, an enclosure component and a first structure component. The hanger includes a base and a handle extending up from the base. The enclosure component is formed of a flexible material and defines an enclosed interior space for holding a payload. The first structure component is formed of a second material and has a predetermined shape. The first structure component is secured to the enclosure component and defines at least a portion of a shape of the package.

### CROSS REFERENCE TO RELATED APPLICATIONS

This application claims priority to U.S. Provisional Application 63/477,982 filed Dec. 30, 2022, the contents of which are incorporated by reference.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to a package configured to be secured by a component of the UAV, such as a payload retriever. With the package secured to the UAV, the payload can be safely transported or raised and lowered by manipulating a tether attached to the payload retriever.

In one aspect a package adapted for use with an uncrewed aerial vehicle (UAV) is provided. The package includes a hanger, an enclosure component and a first structure component. The hanger includes a base, and a handle extending up from the base. The handle has a handle opening and a bridge that extends over the handle opening. The bridge is configured to be secured by a component of the UAV. The enclosure component is formed of a flexible first material and defines an enclosed interior space for holding a payload. The enclosure includes a first side having an upper end attached to the base of the hanger and a lower end, a second side opposite the first side and having an upper end and a lower end, and a bottom extending from the lower end of the first side to a lower end of the second side. The first structure component is formed of a second material and has a predetermined shape. The first structure component being secured to the enclosure component and defining at least a portion of a shape of the package.

In another aspect another package adapted for use with an uncrewed aerial vehicle (UAV) is provided. The package includes a hanger, a container component, and a structural loop component. The hanger includes a base and a handle extending up from the base. The handle includes a handle opening and a bridge that extends over the handle opening. The bridge is configured to be secured by a component of the UAV. The container component is formed of a first material and defines a space for holding a payload. The structural loop component is formed of a second material and includes a first side having an upper end that is suspended from the base of the hanger and a lower end, a second side opposite the first side and having an upper end and a lower end, and a bottom extending from the lower end of the first side to a lower end of the second side. The structural loop supports the container component.

In another aspect yet another package adapted for use with an uncrewed aerial vehicle (UAV) is provided. The package includes a hanger, an enclosure component, a first clamping element, and a second clamping element. The hanger includes a base and a handle extending up from the base. The handle includes a handle opening and a bridge that extends over the handle opening. The bridge is configured to be secured by a component of the UAV. The enclosure component is formed of a flexible first material and defines an enclosed interior space for holding a payload. The enclosure component includes a first side having an upper end and a lower end, a second side opposite the first side and having an upper end and a lower end, and a bottom extending from the lower end of the first side to a lower end of the second side. The first clamping element is formed of a second material and is attached to the base of the hanger. The second clamping element is configured to cooperate with the first clamping element so as to hold a portion of the enclosure component between the first clamping element and the second clamping element.

In another aspect still another package adapted for use with an uncrewed aerial vehicle (UAV) is provided. The package includes a container and a hanger. The container includes a first portion and a second portion. The first portion has an interior side, an exterior side, and a first edge, and the second portion has an interior side configured to face the interior side of the first portion so as to form an interior space for receiving a payload, an exterior side, and a second edge configured to mate with the first edge of the first portion so as to enclose the interior space. The hanger includes a base secured to the first portion of the container, and a handle extending up from the base. The handle includes a handle opening and a bridge that extends over the handle opening. The bridge is configured to be secured by a component of the UAV.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to an example embodiment.

FIG. 1B is a simplified illustration of an uncrewed aerial vehicle, according to an example embodiment.

FIG. 1C is a simplified illustration of an uncrewed aerial vehicle, according to an example embodiment.

FIG. 1D is a simplified illustration of an uncrewed aerial vehicle, according to an example embodiment.

FIG. 1E is a simplified illustration of an uncrewed aerial vehicle, according to an example embodiment.

FIG. 2 is a simplified block diagram illustrating components of an uncrewed aerial vehicle, according to an example embodiment.

FIG. 3 is a simplified block diagram illustrating a UAV system, according to an example embodiment.

FIG. 4 is a lower perspective view of a UAV carrying a package, according to an example embodiment.

FIG. 5 is a side view of a hanger of a package, according to an example embodiment.

FIG. 6A is a perspective view of a payload retriever, according to an example embodiment.

FIG. 6B is a side view of the payload retriever shown in FIG. 6A.

FIG. 6C is a front view of the payload retriever shown in FIGS. 6A and 6B.

FIGS. 7A-7C show decoupling of a payload retriever from a package, according to an example embodiment.

FIG. 8 shows a pair of locking pins extending through a hanger of a package, according to an example embodiment.

FIG. 9 is a perspective view of a package, according to an example embodiment.

FIG. 10 is a perspective view of a portion of a package, according to an example embodiment.

FIG. 11 is a perspective view of a portion of a package, according to another example embodiment.

FIG. 12A is a perspective view of the preparation of a package, according to an example embodiment.

FIG. 12B is a perspective view of a step in the assembly of the package of FIG. 12A.

FIG. 12C is a perspective view of the package of FIG. 12A.

FIG. 13A is a top view of components of a package, according to an example embodiment.

FIG. 13B is a perspective view of the package of FIG. 13A.

FIG. 14 is a side view of a package, according to an example embodiment.

FIG. 15A is a top view of the preparation of a package, according to an example embodiment.

FIG. 15B is a top view of another step in the preparation of the package of FIG. 15A.

FIG. 15C is a perspective view of the package of FIG. 15A.

FIG. 16A is a top view of components of a package, according to an example embodiment.

FIG. 16B is a perspective view of a step in the assembly of the package of FIG. 16A.

FIG. 16C is a perspective view of the package of FIG. 16A.

FIG. 17A is a perspective view of components of a package, according to an example embodiment.

FIG. 17B is a perspective view of a step in the assembly of the package of FIG. 17A.

FIG. 17C is a perspective view of the package of FIG. 17A.

FIG. 18A is a perspective view of components of a package according to an example embodiment.

FIG. 18B is a perspective view of the package of FIG. 18A in an assembled configuration.

FIG. 19A is a perspective view of components of a package according to an example embodiment.

FIG. 19B is a perspective view of the package of FIG. 19A in an assembled configuration.

FIG. 20A is a perspective view of components of a package according to an example embodiment.

FIG. 20B is a perspective view of the package of FIG. 20A in an assembled configuration.

FIG. 21A is a perspective view of a package according to an example embodiment in an open position.

FIG. 21B is a perspective view of the package of FIG. 21A in a closed position.

FIG. 22A is a perspective view of a package according to an example embodiment in an open position.

FIG. 22B is a perspective view of the package of FIG. 22A in a closed position.

FIG. 22C is a perspective view of the package of FIG. 22A with a cap placed over a hanger of the package.

FIG. 23 is a perspective view of a package according to an example embodiment.

FIG. 24A is a perspective view of a package according to an example embodiment in an open position.

FIG. 24B is a perspective view of the package of FIG. 24A in a closed position.

FIG. 25A is a perspective view of a package according to an example embodiment from a first angle.

FIG. 25B is a perspective view of the package of FIG. 25A from a second angle.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

The present embodiments are related to the use of uncrewed aerial vehicles (UAVs) or uncrewed aerial systems (UASs) (referred to collectively herein as UAVs) that are used to carry a package to be delivered or retrieved. As examples, UAVs may be used to deliver or retrieve a package to or from an individual or business. In operation the package to be delivered is secured to the UAV and the UAV is then flown to the desired delivery site. The package may be secured beneath the UAV, positioned within the UAV, or positioned partially within the UAV, as the UAV flies to the delivery site. Once the UAV arrives at the delivery site, the UAV may land to deliver the package, or may be operated in a hover mode while the package is dropped or lowered from the UAV towards the delivery site using a tether and a winch mechanism positioned within the UAV.

The package may enclose a payload, such as goods that are to be delivered by the UAV. The package may protect the goods enclosed therein from weather, dirt, impacts, and other adverse conditions. In some instances, the package may be designed with various features that are intended for securing the package to the UAV and for protecting the goods during flight. Described herein are various embodiments of packages that are adapted to be carried and delivered by a UAV.

In some embodiments, the package includes an enclosure component, such as a bag, for enclosing an interior space for a payload, and a structure component configured to cooperate with the enclosure component to define an exterior shape of the package. A hanger may be secured to the enclosure component and allow the package to be carried by a UAV.

In some embodiments, the package includes a container component for holding a payload, such as a flexible bag or hollow container, and a structural loop component configured to support the container component. The structural loop component may be attached to a hanger for securing the package to a UAV and be configured to transmit loads associated with carrying the payload to the hanger.

In some embodiments, the package includes an enclosure component and a pair of clamping elements configured to clamp around and hold the enclosure component. At least one of the clamping elements may be attached to a hanger to allow the package to be carried by a UAV.

In some embodiments, the package includes a container including first and second portions that are secured to one another along an edge when the container is closed. The package may also include a hanger attached to one of the portions of the container for allowing the package to be carried by a UAV.

Further details and other embodiments of packages according to the disclosure are described in more detail below.

### II. Illustrative Uncrewed Vehicles

Herein, the terms “uncrewed aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

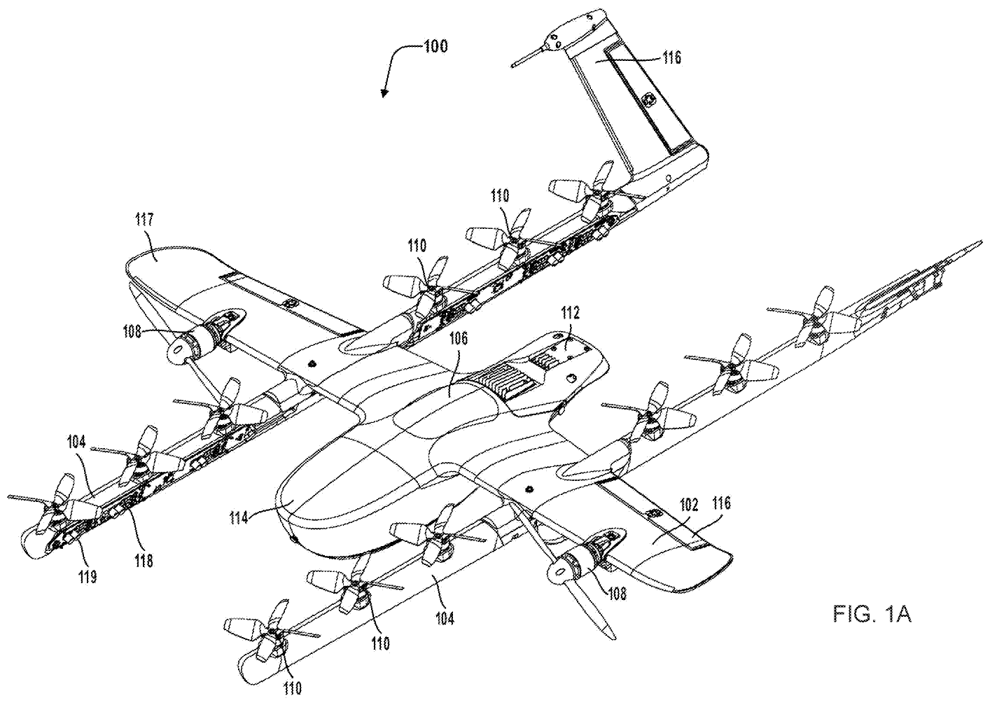

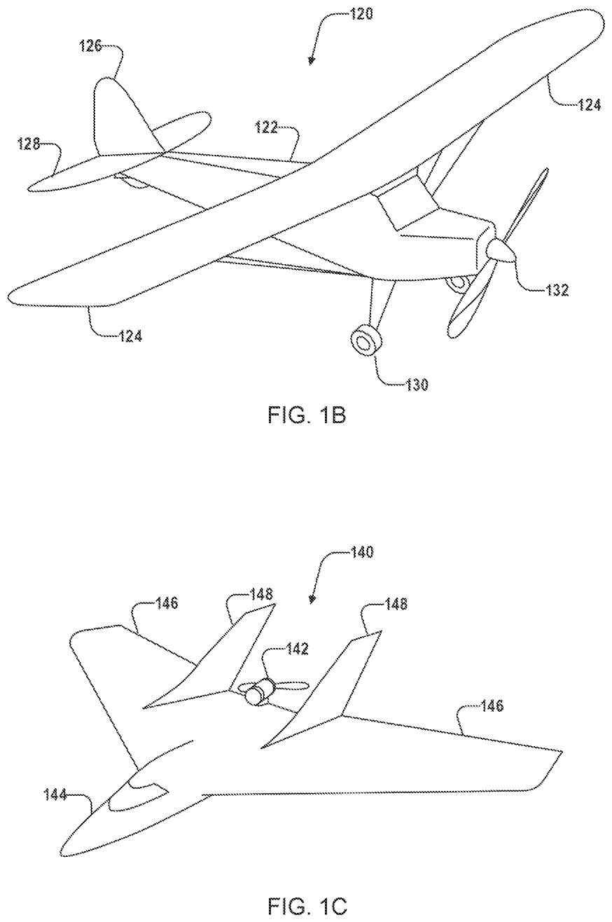

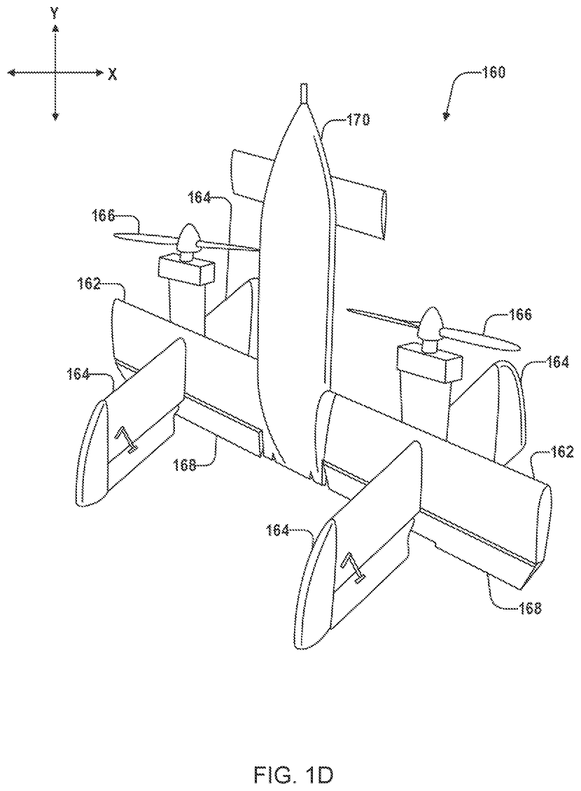

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

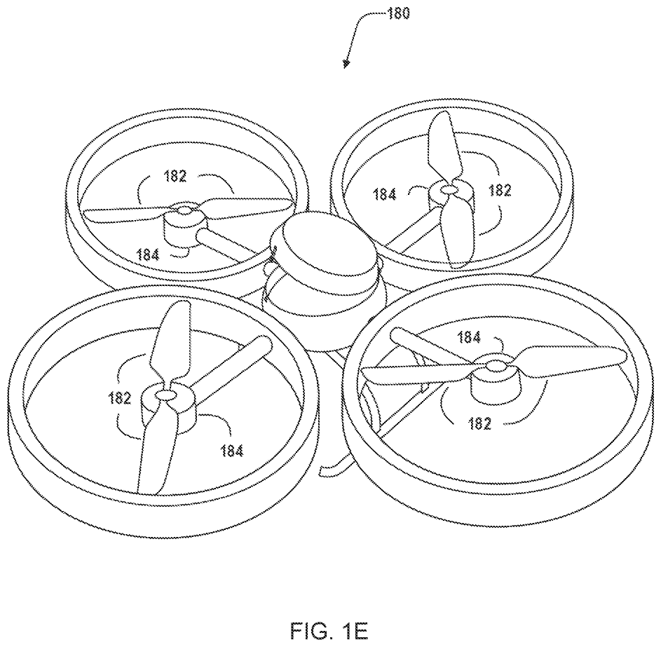

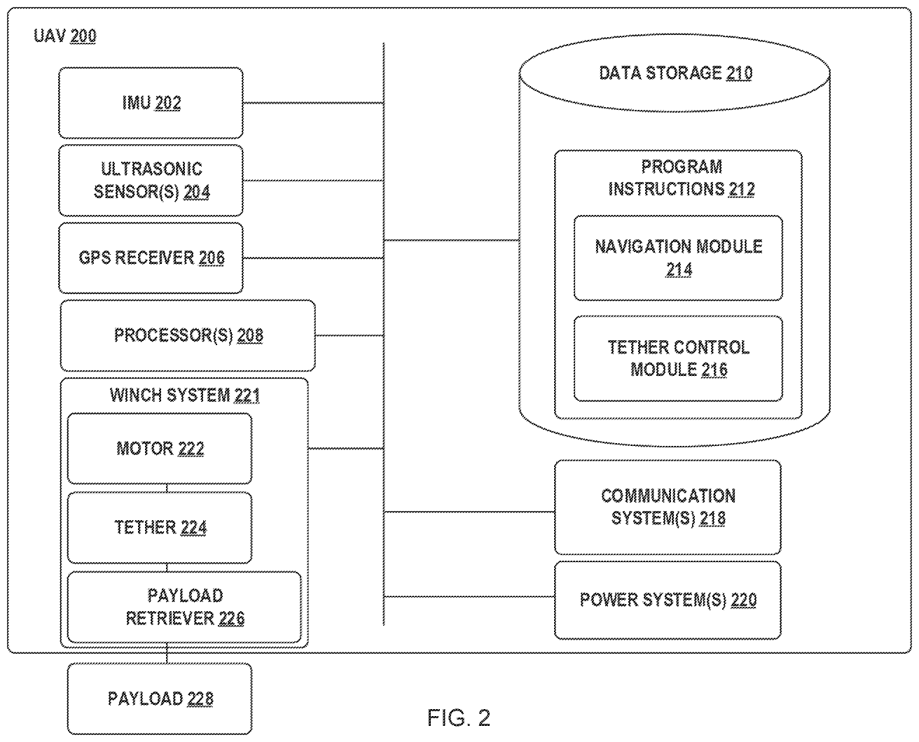

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired operate specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

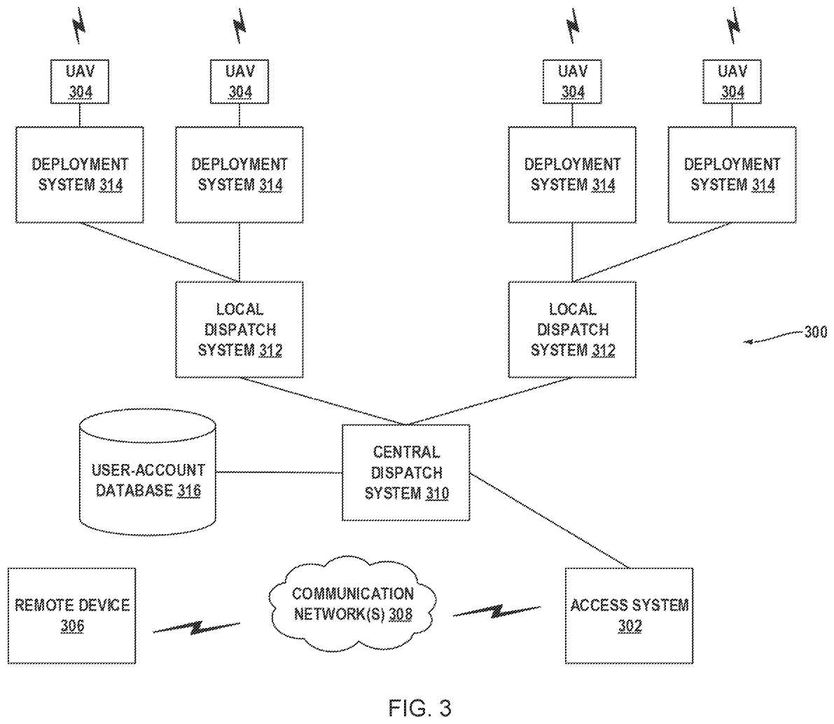

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UA Vs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Example UAV Packaging

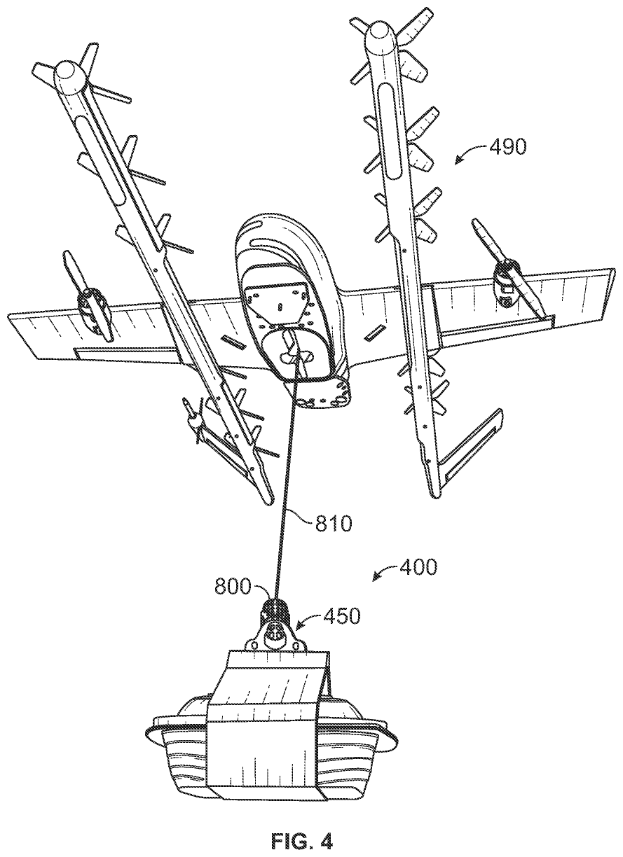

When a UAV is assigned to transport a payload, securing the payload inside of a package that is specifically configured to be received and carried by a UAV can help reduce the likelihood that the package may be dropped, may break, or may substantially increase the drag on the UAV. FIG. 4 illustrates a package 400 according to an embodiment of the disclosure being carried by a UAV 490. The package 400 includes a hanger 450 that is secured to a payload retriever 800 of the UAV 490. The payload retriever 800 is secured to a distal end of a tether 810, which extends from the UAV 490. The UAV 490 is operable to retract or extend the tether 810 in order to raise or lower the package 400.

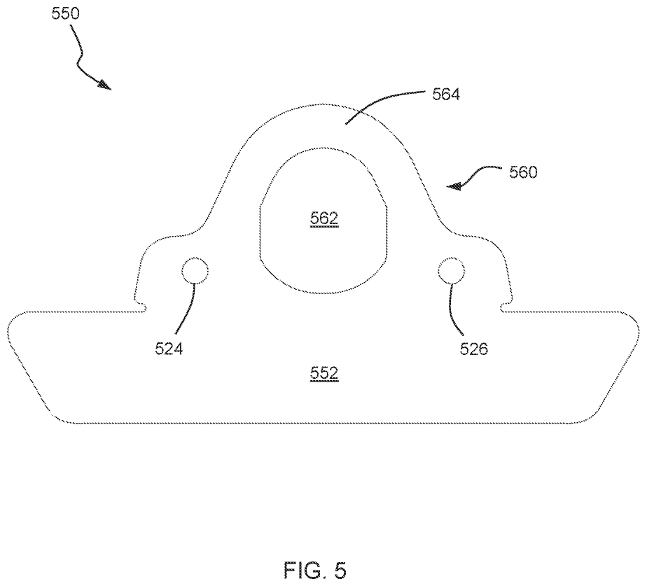

FIG. 5 is a side view of an example hanger 550 which may form part of a package in accordance with the disclosure. The hanger 550 may include a handle 560 formed by a bridge 564 that extends over a handle opening 562. In addition, the hanger 550 may also include a base 552 that extends past the ends of the handle 560 and is configured to couple the hanger 550 to portions of the package that contain or support a payload. The hanger 550 may also include holes 524, 526 that are configured to receive locking pins for securing the package to a component or structure outfitted with such pins. For example, the holes 524 and 526 may be configured to receive locking pins positioned within the fuselage of a UAV to secure the hanger 550 and payload in a secure position during high speed forward flight to a delivery location. In addition, holes 524 and 526 may also be designed for pins of a payload holder to extend therethrough to hold the package in position for retrieval on a payload retrieval apparatus. In some embodiments, the hanger may be comprised of a thin, plastic material or a paper/cardboard material, which may have an embedded reinforcement, such as a carbon fiber strand or metal wire. The hanger may be flexible and provide sufficient strength to suspend the package beneath a UAV during forward flight to a delivery site, and during delivery and/or retrieval of the package. In practice, the hanger may be bent to position the handle within a slot of a payload retriever.

The example hanger 550 shown in FIG. 5 includes a larger handle opening 562 for a payload retriever and two smaller holes 524, 526 for locking pins, as described in more detail below. In other embodiments, however, the hanger may include fewer or more apertures. For example, in some embodiments, the hanger may include only a single larger handle opening that is sized for a payload retriever. In such a case, a payload retriever may be configured to receive the handle in order to raise and lower a package with respect to a UAV, and the payload retriever alone may be used to secure the package to the UAV. Alternatively, the payload retriever may be used in cooperation with other structures, such as clamps or doors, to secure the package to the UAV. Further, in some embodiments, the handle opening may be sized to receive only a locking pin or pins, and the hanger may not include a larger opening for a payload retriever. In such an embodiment, the UAV may be configured to land to receive a package and either land or drop a package for delivery. For example, such an embodiment may have a configuration similar to that of FIG. 5, with two small holes but without the larger opening. Accordingly, either of the holes may form the handle opening and the material extending over the opening may form the bridge of the handle.

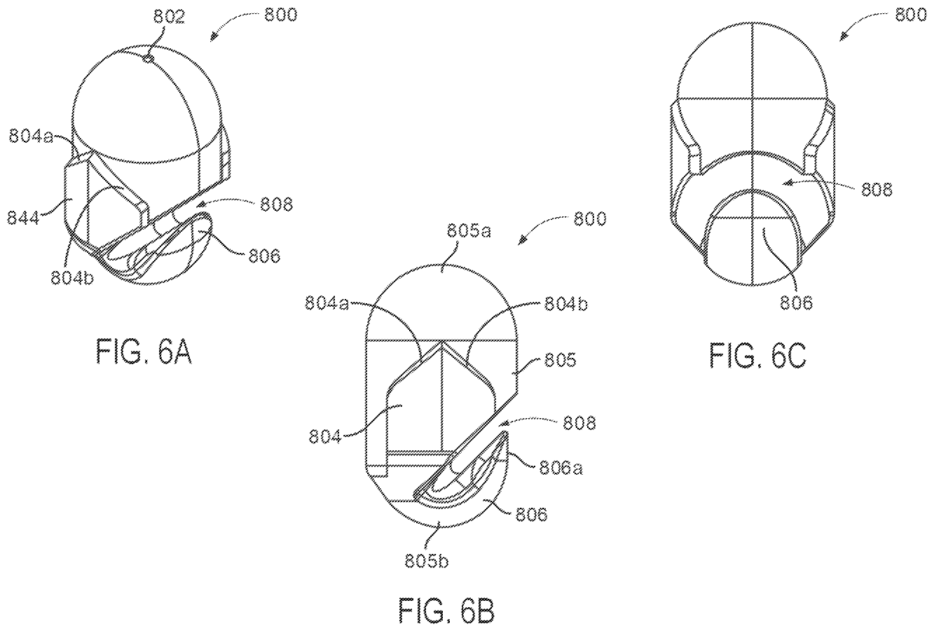

FIG. 6A is a perspective view of a payload retriever 800, according to an example embodiment. Payload retriever 800 includes tether mounting point 802, and a slot 808 to receive a handle of the package coupling apparatus. Lower lip, or hook, 806 is positioned beneath slot 808. Also included is an outer protrusion 804 having helical cam surfaces 804a and 804b that are adapted to mate with corresponding cam mating surfaces within a payload retriever receptacle positioned within a fuselage of a UAV.

FIG. 6B is a side view of payload retriever 800 shown in FIG. 6A. A slot 808 is shown positioned above a lower lip, or hook, 806. As shown lower lip or hook 806 has an outer surface 806a that is undercut such that it does not extend as far outwardly as an outer surface above slot 805 so that the lower lip or hook 806 will not reengage with the handle of the package coupling apparatus after it has been decoupled, or will not get engaged with power lines or tree branches during retrieval to the UAV.

FIG. 6C is a front view of payload retriever 800 shown in FIGS. 6A and 6B. Lower lip or hook 806 is shown positioned beneath slot 808 that is adapted for securing a handle of a payload, such as on a package coupling apparatus of the disclosure.

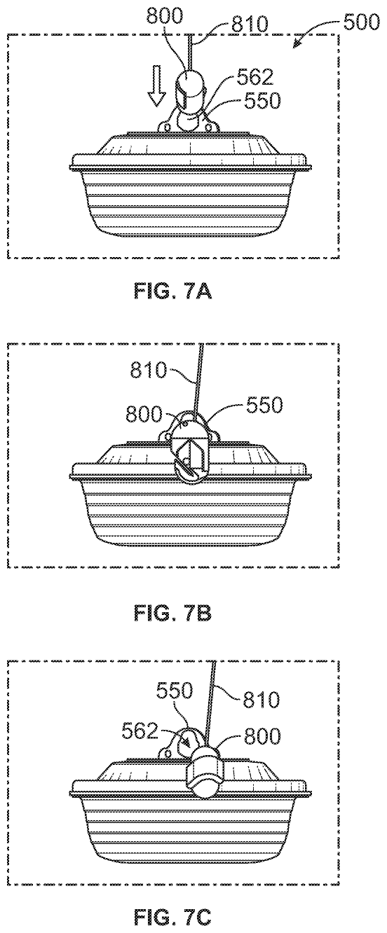

FIG. 7A shows a side view of a package 500 including a hanger 550 secured within a payload retriever 800. The package 500 and payload retriever 800 are moving downwardly prior to touching down for delivery. The hanger 550 of the package 500 includes a handle opening 562 through which a lower lip or hook of payload retriever 800 extends. The handle sits within a slot of the payload retriever 800, which is suspended from a tether 810 during descent of the package 500 to a landing site.

FIG. 7B shows a side view of package 500 after package 500 has landed on the ground and the payload retriever 800 has decoupled from hanger 550 of package 500. Once the package 500 touches the ground, the payload retriever 800 continues to move downwardly (as the winch further unwinds) through inertia or gravity and decouples the hanger 550 from the slot 880 of the payload retriever 800 from hanger 550. The payload retriever 800 remains suspended from tether 810, and can be winched back up to the payload coupling receptacle of the UAV.

FIG. 7C shows a side view of package 500 with payload retriever 800 moving away from hanger 550 of package 500. Here the payload retriever 800 is completely separated from the handle opening 562 of hanger 550. Tether 810 may be used to winch the payload retriever back to a receptacle positioned in the fuselage of the UAV.

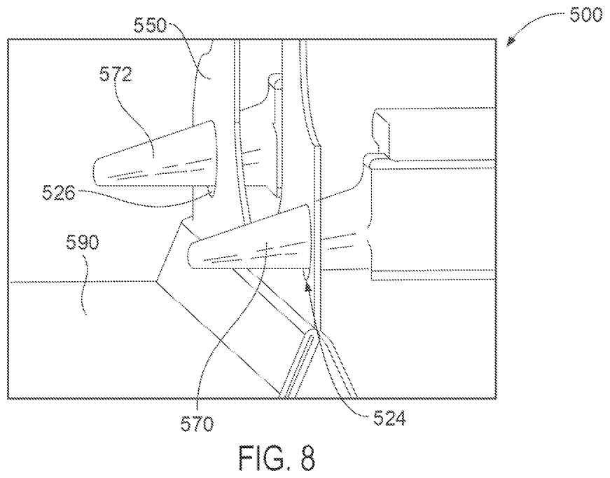

FIG. 8 shows a pair of pins 570, 572 extending through holes 524 and 526 in a hanger 550 of a package 500 to secure the hanger 550 within the fuselage of a UAV, or to secure the package 500 to a payload holder of a payload retrieval apparatus. In this manner, the hanger 550 and package 500 may be secured within the fuselage of a UAV, or to a payload holder of a payload retrieval apparatus. In this embodiment, the pins 570 and 572 have a conical shape which allows them to be easily inserted into the holes 524 and 526. In some embodiments, the shape of the pins may be configured to retain a package thereon. Further, in some embodiments, the pins may be angled upward to hold the package onto the pins. In some embodiments the pins 570 and 572 may completely plug the holes 524 and 526 of the hanger 550 of package 500, to provide a secure attachment of the handle and top portion of the payload within the fuselage of the UAV, or to secure the payload to a payload retrieval apparatus. Although the pins are shown as conical, in other applications they may have other geometries, such as a cylindrical geometry.

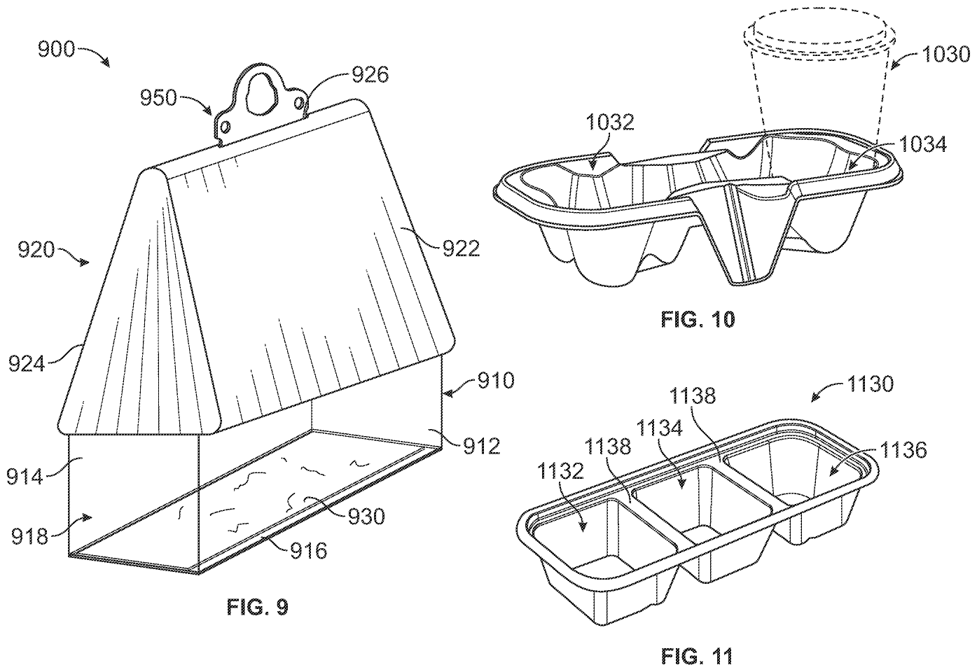

FIG. 9 illustrates a package for transport and delivery by a UAV in accordance with an embodiment of the disclosure. Package 900 includes a hanger 950 adapted to be received by a payload retriever of a UAV and an enclosure component 910 for holding a payload. The enclosure component 910 may be formed of a flexible material, such as plastic sheet, fabric, paper or another flexible material. Accordingly, the enclosure component 910 may have the form of a flexible bag that defines an interior space 918 for holding a payload. The enclosure component 910 of package 900 may include a first side 912 and a second side 914 opposite the first side 912, with the interior space 918 provided between the two sides 912, 914. The enclosure component 910 also includes a bottom 916 that extends from a lower end of the first side 912 to a lower end of the second side 914. The bottom 916 closes the lower end of the package 900 and provides support for any payload placed inside the package 900.

In some embodiments, the first side, second side and bottom of the enclosure component may be delimited by structural features that identify boundaries between the first side, second side and bottom, such as creases, seams or folds. Such structural features may or may not connect to the hanger for transferring loads from the enclosure component to the hanger. In other embodiments, the sides of the enclosure component are identifiable based on their positions but may not include structural boundaries. For example, in some embodiments, a single continuous piece of material may form the first side, bottom and second side of the enclosure component, where a payload within the interior space is positioned above the bottom and between the two sides. In some embodiments, the enclosure component may also include lateral sides extending between the first side and the second side, such that the interior space is surrounded by four sides. In other embodiments, the first and second side may be directly attached to one another, in a manner similar to an envelope. Further, in some embodiments, the first and second sides of the enclosure component may be spaced apart and the ends be left open.

The enclosure component 910 is attached to the hanger 950 such that the load associated with supporting a payload in the enclosure component 910 is transferred from the enclosure component 910 to the hanger 950. Accordingly, a UAV can lift and move the package 900 and payload therein by carrying the hanger 950.

In some embodiments, the enclosure component is fixedly attached to the hanger. For example, depending on the materials of the hanger and enclosure component, the enclosure component may be heat welded or otherwise bonded to the hanger. Alternatively, the enclosure component may be secured to the hanger using an adhesive. Similarly, the enclosure component may be secured to the hanger using a fixed fastener, such as a rivet that passes through apertures in the enclosure component and hanger. Further still, the enclosure component and hanger may be formed of the same material and integrally formed in a single piece.

In other embodiments, the enclosure component may be removably attached to the hanger. For example, the enclosure component may be secured to the hanger with removable fasteners, such as clips, snaps, or threaded fasteners. Alternatively, the hanger may be configured to clamp onto the enclosure component, using a clamping structure as described in further detail below.

Package 900 also includes an upper structure component 920 that is configured to extend around the payload and sit adjacent to the first side 912 and second side 914 of the enclosure component 910. Specifically, upper structure component 920 is configured as a sheath that extends around the bag that forms enclosure component 910. Upper structure component 920 includes a first side 922 and a second side 924 opposite the first side 922. Each of the sides 922 and 924 of upper structure component 920 is configured to sit adjacent to a respective side 912, 914 of the enclosure component 910. The upper structure component 920 also includes an aperture 926 allowing a portion of the hanger 950 to pass therethrough. Accordingly, the handle 952 of hanger 950 extends through the aperture 926 and upward from the upper structure component 920, which hangs on the base of the hanger 950.

The upper structure component 920 has a predetermined shape with an open interior to provide space for a payload. In some embodiments, the sides of the enclosure component may be attached to the interior of the upper structure component, such as with an adhesive, so that the sides of the enclosure component are spread apart and against the sides of the upper structure component. In other embodiments, the enclosure component may loosely fit within the upper structure component.

In some embodiments, the upper structure component 920 has an aerodynamic shape to reduce drag caused by the package 900 as the UAV flies. For example, the upper structure component may form a narrow body that is configured to be aligned with the direction of travel of the UAV. Further, the upper structure component may taper toward the front and/or rear of the package to limit drag.

While the upper structure component 920 of package 900 is configured to be positioned outside the enclosure component 910, in other embodiments, the upper structure component may be positioned inside the enclosure component. For example, in some embodiments, the upper structure component may be positioned in the interior of the enclosure component with the enclosure component extending around the upper structure component. In such an embodiment, the shape of the upper end of the enclosure component may be influenced by the shape of the upper structure.

The upper structure component may be formed of various different materials that are able to maintain a certain shape. For example, the upper structure component may be formed of paper or cardboard. For weather protection, when the upper structure component is positions outside the enclosure component, the upper structure component may have a protective coating, such as a polymer film, wax, or other water resistant coating. In other embodiments, the upper structure may be formed of another material, such as a plastic, metal, reinforced fabric, or a combination thereof.

Package 900 also includes a lower structure component 930 that is adjacent to the bottom 916 of the enclosure component 910. The lower structure component 930 has a predetermined shape and cooperates with the enclosure component 910 to provide a desired shape to the enclosure component 910. In package 900 the lower structure component 930 is disposed in the interior space 918 and rests on the bottom 916 of the enclosure component 910. As a result, the lower structure component 930 pushes the first side 912 and second side 914 away from one another to hold the interior space 918 open. Specifically, the lower structure component 930 extends across the entire bottom 916 of the enclosure component 910 and contacts both the first side 912 and the second side 914. This provides a larger interior within the enclosure component 910 for receiving payloads therein.

While the lower structure component 930 of package 900 is configured to be positioned inside the enclosure component 910 and resting on the bottom 916, in other embodiments, the lower structure component may be positioned on the outside of the enclosure component. For example, in some embodiments, the lower structure component may be positioned on the outside of the enclosure component and an outer surface of the enclosure component may be adhered or fastened to the lower structure component. Accordingly, the enclosure component may be expanded to have an open interior space through the attachment of the bottom of the enclosure component to the lower structure component.

While package 900 includes both an upper structure component 920 and a lower structure component 930, in other embodiments, the package may include only one structure component. For example, in some embodiments, the package may include a single structure component similar to the upper structure component 920 of package 900 that cooperates with the first and second sides of the enclosure component. In other embodiments, the package may include a single structure component similar to the lower structure component 930 of package 900 that is adjacent to the bottom of the enclosure component. Further still, in some embodiments, the package may include a single structure component that cooperates with both the sides and the bottom of the enclosure component.

In package 900 the lower structure component 930 is formed as a flat platform. However in other embodiments, the lower structure component may have other shapes. For example, FIG. 10 shows a lower structure component 1030 that is formed as a cup holder for storing two cups. Specifically, lower structure component 1030 has a first receptacle 1032 for receiving a first cup and a second receptacle 1034 for receiving a second cup. Each of the receptacles is formed as a cavity that is configured to receive a respective cup. FIG. 11 shows another embodiment of a lower structure 1130 that includes three receptacles 1132, 1134, 1136. Each of the receptacles 1132, 1134, 1136 is formed as a separate cavity and the receptacles are delimited by dividers 1138 that separate the receptacles from each other.

The lower structure component may be formed of various different materials. For example, where the lower structure has a basic shape, the lower structure component may be formed by a flat sheet of cardboard, plastic or a similar material. In other embodiments, the lower structure component may have a more complex shape and be formed of folded, molded, or stamped materials, including folded cardboard, molded pulp material, shaped foil, or other materials.

In some embodiments, the structure component(s) of the package may be formed of a different material than the enclosure component. For example, the enclosure component may be formed of a flexible plastic bag while the enclosure components are formed of a cardboard material. Forming the enclosure component and structure component of different materials allows the two components to be engineered to address different challenges. For example, the structure component may be tailored to provide the package with desirable aerodynamics while the enclosure component may be designed to provide protection of the payload from wind and moisture. Other combinations of benefits of the differing materials is also possible.

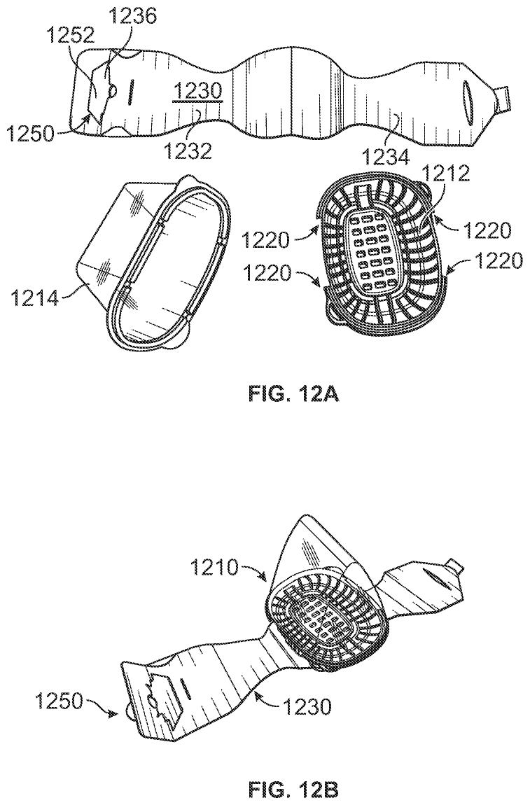

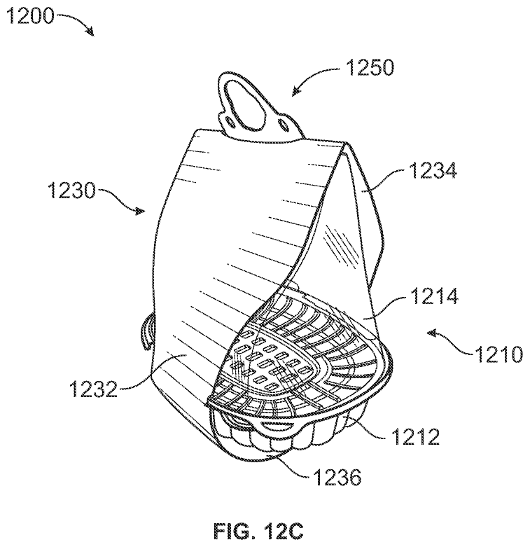

FIGS. 12A-12C illustrate a package for transport and delivery by a UAV in accordance with another embodiment of the disclosure. As shown in FIG. 12C, package 1200 includes a hanger 1250 adapted to be received by a payload retriever of a UAV, a container component 1210 that defines a space for a payload, and a structural loop component 1230 that supports the container component 1210 and transfers loads from the container component 1210 to the hanger 1250. The container component 1210 is formed of a vessel 1212 and a lid 1214 that are configured to couple to one another and form an enclosed interior space for holding a payload. In package 1200, the container component 1210 is formed of a relatively stiff material that retains a desired shape. Accordingly, the container component 1210 may be formed to have an aerodynamically advantageous shape, such that drag caused by the package 1200 is reduced. On the other hand, in other embodiments, the container component may be formed of a different material, such as a more flexible material, and have a different configuration, as explained below.

The structural loop component 1230 is formed as a wide strip that is attached to the hanger 1250 and extends down to support the container component. Accordingly, the structural loop component includes a first side 1232 having an upper end that is suspended from the base of the hanger 1250, a second side 1234, and a bottom 1236 that extends from a bottom end of the first side 1232 to a bottom end of the second side 1234. Further, the upper end of the first side 1232 is secured to the upper end of the second side 1234.

In package 1200, each of the first side 1232 and the second side 1234 is secured directly to the hanger 1250. However, in some embodiments, the first side of the structural loop component may be secured to the hanger, while the second side of the structural loop component is attached to the first side but not directly secured to the hanger.

FIG. 12A shows the various components of package 1200 in a disassembled arrangement. As shown, the lid 1214 of the container component 1210 is removable from the vessel 1212 in order to access the interior space. The structural loop component 1230 is formed of a reinforced paper product or plastic sheet that can sufficiently transfer the load of the payload to the hanger 1250. The first side 1232 of the structural loop component 1230 includes an aperture 1236 for receiving the hanger 1250. The aperture 1236 is sized to be smaller than the base 1252 of the hanger 1250, so that the structural loop component 1230 can be suspended from the hanger 1250 when the upper portion of the hanger 1250 extends through the aperture 1236. The second side 1234 of the structural loop component 1230 may also include a similar aperture 1238 for suspending the second side 1234 of the structural loop component from the hanger. This configuration allows for the load to be effectively transferred from the structural loop component 1230 to the hanger 1250, while also securing the two sides 1232, 1234 of the structural loop component 1230 together. In other embodiments, the two sides of the structural loop component may be secured to one another by another method, such as with adhesive, fasteners such as staples, or insert tabs.

As explained above with respect to the enclosure component, the sides and bottom of the structural loop component may or may not be delimited by structural features.

The container component 1210 of the package 1200 includes notches 1220 on either side that are configured to receive respective sides 1232, 1234 of the structural loop component 1230. The placement of the structural loop component within the notches 1220 helps securely retain the container component 1210 within the structural loop component 1230 without the need for additional components. However, in other embodiments, the container component may be fastened or adhered in place within the structural loop component.

The lid 1214 of container component 1210 is configured to follow the shape of the structural loop component 1230 so as to form a peak near the hanger 1250. Accordingly, the combination of the container component 1210 and structural loop component 1230 cooperate to form an aerodynamic shape that limits drag caused by the package 1200.

In some embodiments, the structural loop component of the package may be formed of a different material (or different materials) than the container component. For example, the structural loop component may be formed of a material that has sufficient strength to support the payload and transfer the associated load to the hanger, while the container component may be formed of one or more materials designed to contain the payload and protect the payload from environmental conditions. In some embodiments, the structural loop component may be formed of a weatherproof material or include a weatherproof coating. Likewise, in some embodiments, the container component may be formed of a weatherproof material or include a weatherproof coating. Further still, in some embodiments, both components may include such weatherproof materials or coating.

While the container component 1210 of package 1200 is formed by a vessel 1212 and lid 1214 that are substantially rigid and retain their shape, in other embodiments, the container component may be formed of a more flexible material. For example, FIGS. 13A and 13B illustrate another package that includes a container component in the form of a bag made of a flexible material.

Package 1300 includes a bag 1310 that is configured to hold a payload. The upper end of the bag 1310 is connected to a hanger 1350 that includes a first hanger portion 1352 secured to a first side 1312 of the bag 1310 and a second hanger portion 1354 secured to a second side 1314 of the bag 1310. The bag forms an interior space that is adapted to hold and protect a payload, and thus, the bag 1310 acts as both an enclosure component and/or a container component.

Package 1300 also includes a structural loop component 1330 that is configured to support a payload disposed within the bag 1310. The structural loop component 1330 of package 1300 is formed by plastic reinforcement that extends from the first hanger portion 1352, down the first side 1312, across the bottom 1316 of the bag, and up the second side 1314 to the second hanger portion 1354. Accordingly, the structural loop component 1330 provides structural support to the bottom of the 1310 for transferring loads from the bottom of the bag 1310 up to the hanger 1350. In some embodiments, the reinforcement that forms the structural loop component 1330 may be integrally formed with the bag 1310, for example by sonic welding the reinforcement to the bag or incorporating the reinforcement into the bag during manufacturing.

Package 1300 also includes a first structure component 1340 that helps define the shape of bag 1310. The first structure component 1340 is configured as a platform that is configured to be inserted inside the bag 1310 and rest on the bottom 1316 of bag 1310. The first structure component 1340 may be formed of a stiffer material than bag 1310 and thereby separate the opposing sides of the bag 1310 to maintain an open interior inside the bag 1310. The first structure component 1340 of package 1300 is formed of a corrugated cardboard sheet. However, as set forth above, the first structure component may be formed of various other materials.

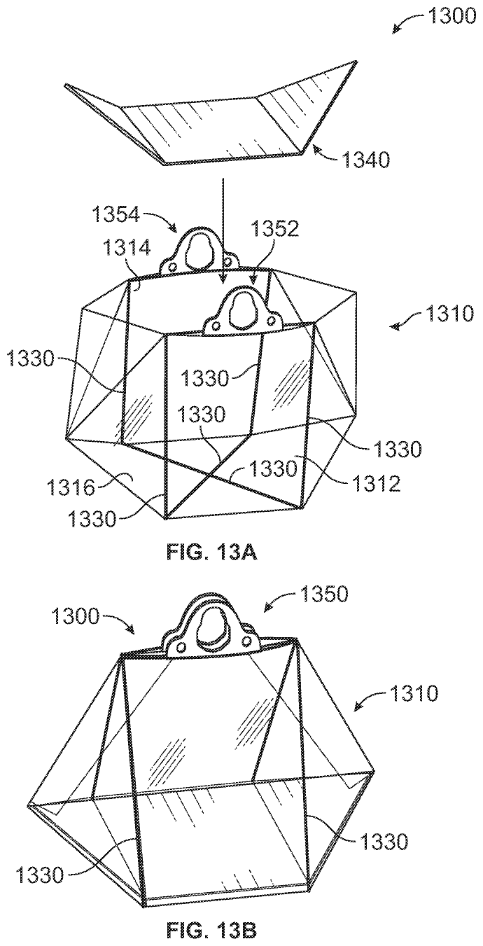

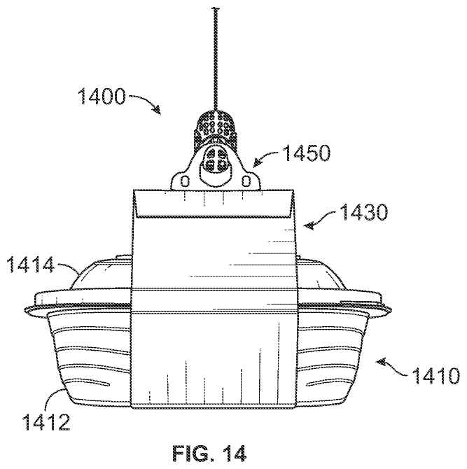

While the container component 1210 of package 1200 has a shape that conforms to the shape of the structural loop component 1230, such that the lid 1214 extends upward with the structural loop component 1230 to the hanger 1250, in other embodiments, the shapes of the container component and structural loop component may not conform to one another. For example, package 1400, shown in FIG. 14 includes a container component 1410 formed of a vessel 1412 in the shape of a bowl and a shallow lid 1414 that attaches to the vessel. Package 1400 also includes a structural loop component 1430 that loops under the container component 1410 and extends upward to a hanger 1450. In view of the shallow shape of lid 1414, the structural loop component 1430 extends upward from the top of the lid 1414.

Further, while the structural loop components of packages 1200 and 1400 extend around the outside of their respective container components, in other embodiments, the structural loop component may be inside the container component. For example, FIGS. 15A-15C show a package for transport and delivery by a UAV in accordance with another embodiment of the disclosure. As shown in FIG. 15A, package 1500 includes a structural loop component 1530 that is inserted inside a container component 1510 in the form of a bag. The structural loop component 1530 includes apertures for receiving a hanger 1550 in order to attach the hanger 1550 to the structural loop component 1530 and transfer loads from the structural loop component to the hanger 1550. Once the structural loop component 1530 is inside the bag that forms the container component 1510, the bag may be closed around the structural loop component 1530.

In package 1500, the structural loop component 1530 is configured to extend under the payload and transfer the load of the payload to the hanger 1550, while the container component 1510 provides the package with weather protection and an aerodynamic shape. In particular, the container component 1510 of package 1500 has a long narrow shape with pointed ends for limiting drag.

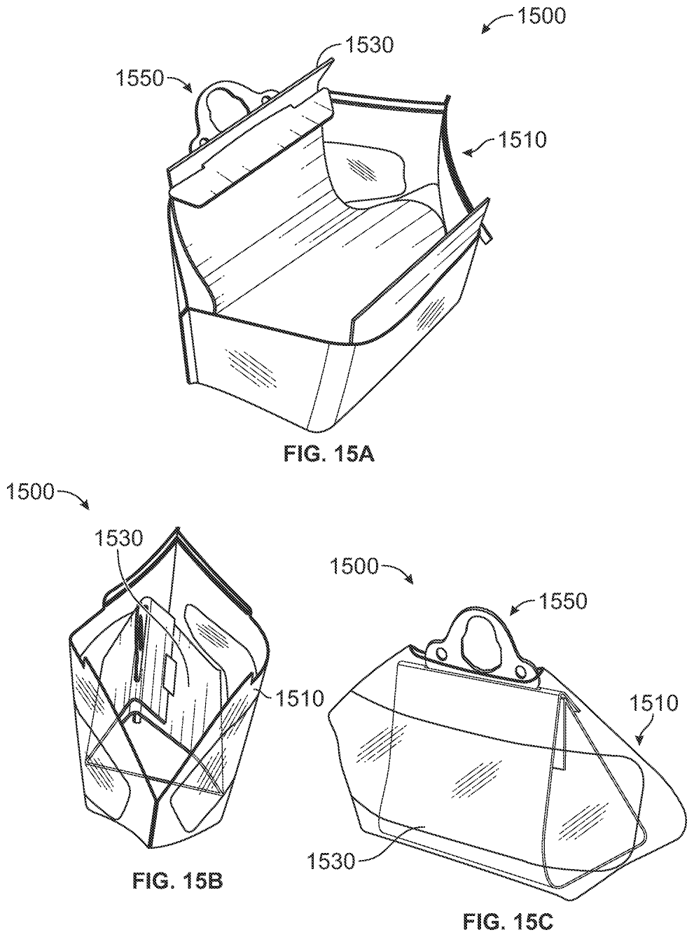

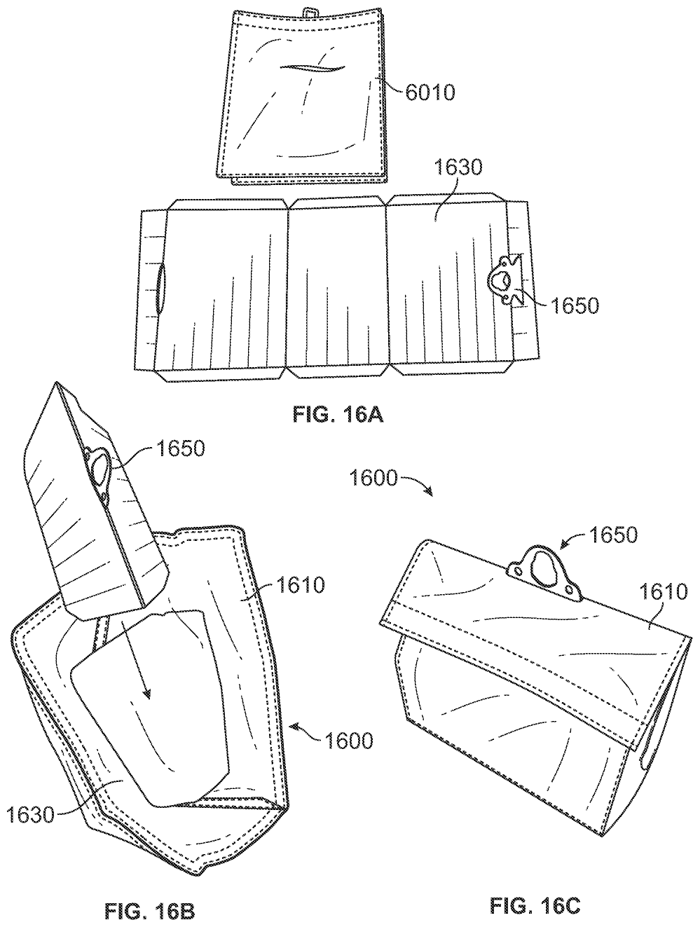

FIGS. 16A-16C show a package for transport and delivery by a UAV in accordance with another embodiment of the disclosure. Package 1600 has a similar configuration to package 1500. Specifically, package 1600 includes a structural loop component 1630 that is inserted inside a container component 1610 in the form of a bag. The structural loop component 1630 includes apertures for receiving a hanger 1650 in order to attach the hanger 1650 to the structural loop component 1630. The structural loop component 1630 is then placed inside the container component 1610 such that the container component 1610 may be closed around the structural loop component 1630. Package 1600 does not have the same aerodynamic shape as package 1500 and illustrates that features of the disclosure may be used with various different types of packages.

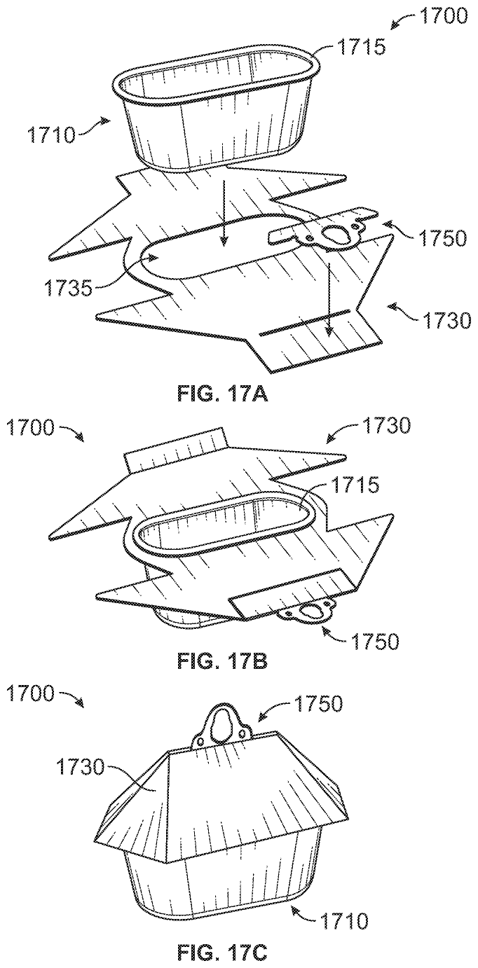

While the foregoing structural loop components have each been configured to extend below the payload, in other embodiments, the structural loop component may support the payload without extending underneath the payload. For example, FIGS. 17A-17C show a package for transport and delivery by a UAV in accordance with another embodiment of the disclosure. Package 1700 includes a container component 1710 in the form of a vessel, a structural loop component 1730 that supports the container component 1710, and a hanger 1750. The structural loop component 1730 transfers loads from the container component 1710 to the hanger 1750. Rather than extending below the vessel 1710, structural loop component 1730 includes a hole 1735 adapted to receive the vessel 1710. To prevent the vessel 1710 from falling through the hole 1735, the vessel 1710 includes a circumferential flange 1715 that is larger than the diameter of the hole. As a result, when the vessel 1710 is supported by the structural loop component 1730, most of the vessel and a portion of the payload therein is positioned below the bottom of the structural loop component 1730.

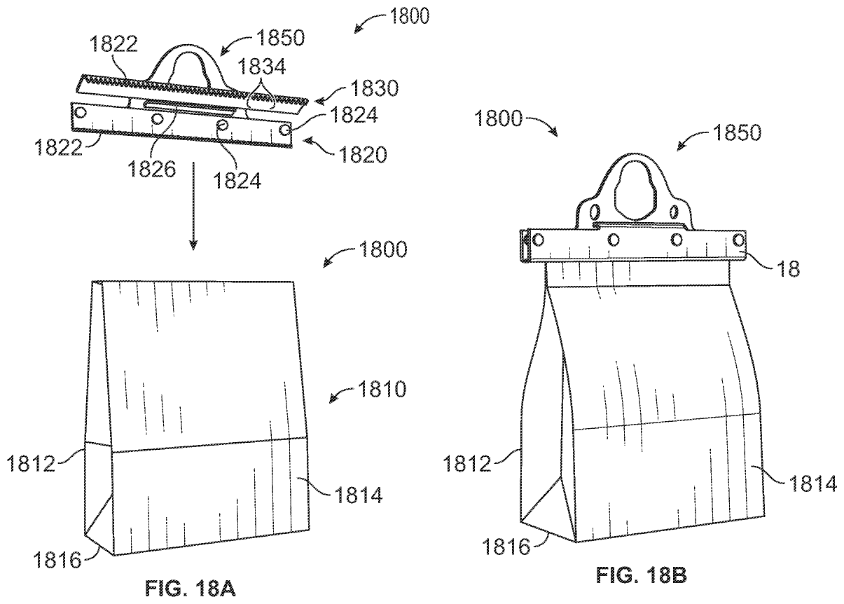

FIGS. 18A and 18B illustrate a package for transport and delivery by a UAV in accordance with another embodiment of the disclosure. As shown in FIG. 18A, package 1800 includes a hanger 1850 adapted to be received by a payload retriever of a UAV and an enclosure component 1810 for holding a payload. The enclosure component 1810 may be formed of a flexible material, such as plastic sheet, fabric, paper or another flexible material. Accordingly, the enclosure component 1810 may have the form of a flexible bag that defines an interior space for holding a payload. The enclosure component 1810 of package 1800 may include a first side 1812 and a second side 1814 opposite the first side 1812, with the interior space provided between the two sides 1812, 1814. The enclosure component 1810 also includes a bottom 1816 that extends from a lower end of the first side 1812 to a lower end of the second side 1814. The bottom 1816 closes the lower end of the package 1800 and provides support for any payload placed inside the package 1800.

Again in various embodiments, the first side, second side and bottom of the enclosure component may or may not be delimited by structural features that identify boundaries therebetween. Further, in some embodiments, the enclosure component may also include lateral sides extending between the first side and the second side, while in other embodiments, the first and second sides may be directly attached to one another or open therebetween.

Package 1800 also includes a first clamping element 1820 attached to the hanger 1850. In some embodiments, the first clamping element is fixedly attached to the hanger. For example, in package 1800, the first clamping element 1820 is integrally formed with the hanger 1850 in a single piece. In other embodiments, depending on the materials of the hanger and first clamping element, the hanger and clamping element may be bonded to each other or attached using an adhesive. Similarly, the first clamping element may be secured to the hanger using fasteners.

In other embodiments, the hanger may be removably attached to the first clamping element. For example, the hanger may extend through a hole in the first clamping element such that the first clamping element hangs on the base of the hanger. In other embodiments, the first clamping element may be secured to the hanger with removable fasteners, such as clips, snaps, or threaded fasteners.

Package 1800 also includes a second clamping element 1830 that is configured to cooperate with the first clamping element 1820 so as to hold a portion of the enclosure component 1810 between the first clamping element 1820 and second clamping element 1830. The clamping elements 1820, 1830 may be configured to engage a structural portion of the enclosure component 1810 so that loads associated with the payload within the enclosure component 1810 can be transferred to the clamping elements. Moreover, by securely attaching the first clamping element to the hanger, the load can further be transferred to locking pins that extend through holes in the hanger or to a payload retriever that holds the bridge of the hanger.

The first clamping element 1820 and second clamping element 1830 of package 1800 each include teeth 1822 that are configured to stick into the surface of the enclosure component 1810 in order to securely hold the enclosure component 1810 in place between the first clamping element 1820 and second clamping element 1830, as shown in FIG. 18B. Other embodiments of the clamping elements may have other engagement structures for securing the enclosure component between the clamping elements, such as friction pads or other structures described in more detail below.

The first clamping element 1820 also includes fasteners 1824 configured to mate with corresponding fasteners 1834 of the second clamping element 1830. The opposing fasteners 1824, 1834 may be configured to couple to one another when the clamping elements are moved to a closed position that engages the enclosure component 1810. As a result, the clamping elements 1820, 1830 may have a locked position in which the clamping elements are latched together.

The second clamping element 1830 of package 1800 is secured to the first clamping element 1820 by a hinge 1826. The hinge 1826 keeps the two components together and aligned so that engagement structures or fasteners may cooperate easily without the need for a user to align the clamping elements. The hinge 1826 may also be spring loaded to a closed position. The use of a spring to hold the hinge 1826 may assist in maintaining a secure attachment of the bag that forms enclosure component 1810 within the clamping elements 1820, 1830.

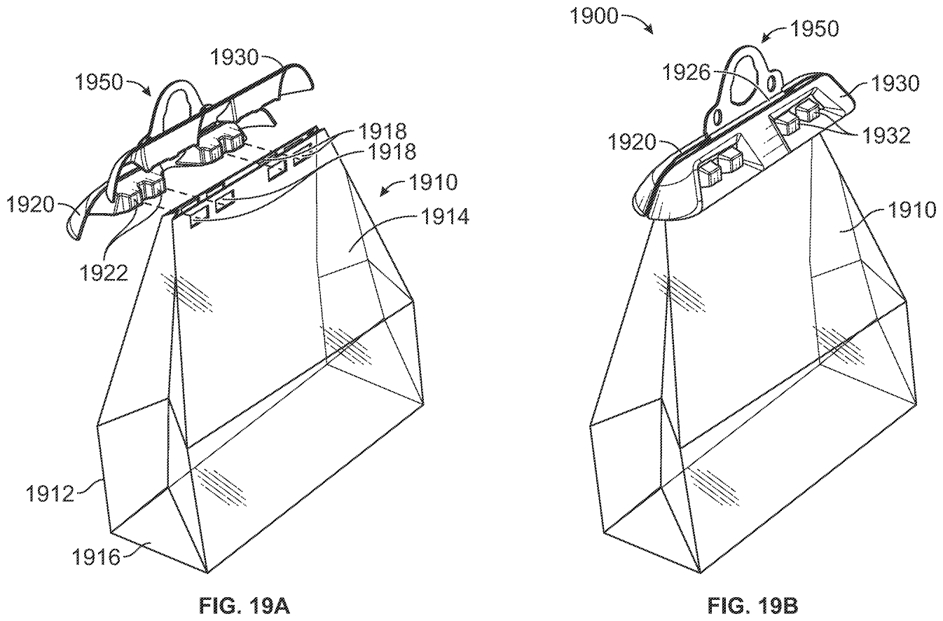

FIGS. 19A and 19B illustrate a package for transport and delivery by a UAV in accordance with another embodiment of the disclosure. As shown in FIG. 19A, package 1900 includes a hanger 1950 adapted to be received by a payload retriever of a UAV and an enclosure component 1910 for holding a payload. The enclosure component 1910 may take the form of a bag and be formed of a flexible material, similar to the enclosure component of package 1800. The enclosure component 1910 of package 1900 may include a first side 1912 and a second side 1914 opposite the first side 1912, with the interior space provided between the two sides 1912, 1914. The enclosure component 1910 also includes a bottom 1916 that extends from a lower end of the first side 1912 to a lower end of the second side 1914. The bottom 1916 closes the lower end of the package 1900 and provides support for any payload placed inside the package 1900. Again, the sides and bottom may be delimited by structural features or may be identified by their positions without visible boundaries.

Package 1900 also includes a first clamping element 1920 attached to the hanger 1950 and a second clamping element 1930. In package 1900, the first clamping element 1920 is integrally formed with the hanger 1950 in a single piece. The second clamping element 1930 is configured to cooperate with the first clamping element 1920 in order to hold a portion of the enclosure component 1910 between the first clamping element 1920 and second clamping element 1930.

To facilitate attachment between the first clamping element 1920 and second clamping element 1930 of package 1900, the clamping elements include respective fastening structures. Specifically, first clamping element 1920 includes fastening plugs 1922 and second clamping element 1930 includes receptacles 1932 configured to receive the fastening plugs 1922 of first clamping element 1920. To connect the first clamping element 1920 to the second clamping element 1930, the fastening plugs 1922 are secured in the receptacles 1932 of the second fastening element 1930, for example with a snap-fit connection, as shown in FIG. 19B.

In addition to securing the enclosure component 1910 between the two clamping elements 1920, 1930, the enclosure component 1910 may also include apertures 1918 configured to receive the fastening plugs 1922 therein. Accordingly, when the first clamping element 1920 is attached to the second fastening element 1930, the fastening plugs 1922 pass through the apertures 1918 and act as hooks that suspend the enclosure component 1910.

Similar to package 1800, the first clamping element 1920 and second clamping element 1930 of package 1900 are attached to one another by a hinge 1926 (FIG. 19B). The hinge 1926 keeps the two components together and aligned so that the fastening plugs 1922 and receptacles 1932 may cooperate easily without the need for a user to align the clamping elements. The hinge 1926 may also be spring loaded to a closed position. The use of a spring to hold the hinge 1926 may assist in maintaining a secure attachment of the bag that forms enclosure component 1910 within the clamping elements 1920, 1930.

While package 1900 includes fastening plugs on the first clamping element and receptacles on the second clamping element, in other embodiments, the fastening plugs may be provided on the second clamping element. Moreover, in some embodiments, the first clamping element may have a mix of fastening plugs and receptacles while the second clamping element may have a complementary mix of receptacles and fastening plugs. Further, in other embodiments the clamping elements may include other forms of fastening structures entirely.

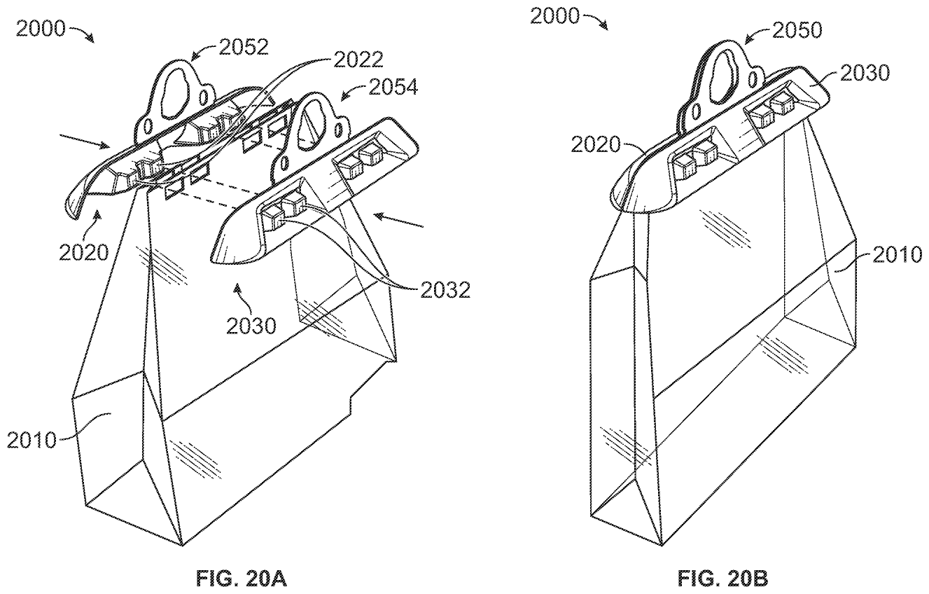

FIGS. 20A and 20B illustrate a package for transport and delivery by a UAV in accordance with another embodiment of the disclosure. As shown in FIG. 20A, package 2000 has a similar configuration to package 1900. Specifically, package 2000 includes an enclosure component 2010 that may be secured between a first clamping element 2020 and a second clamping element 2030, as shown in FIG. 20B. Further, the enclosure component 2010 includes apertures 2012 that receive the fastening plugs 2022 of the first clamping element 2020, which are secured in receptacles 2032 of the second clamping element 2030.

Package 2000 also includes a hanger 2050 for retrieving the package 2000 by a UAV. As with some previously described hangers, hanger 2050 of package 2000 includes a first hanger portion 2052 and a second hanger portion 2054. The two hanger portions 2052, 2054 have similar constructions and each include openings for a payload retriever and holes for locking pins. Each of the two hanger portions 2052, 2054 are respectively secured to the first clamping element 2020 and the second clamping element 2030. When the two clamping elements 2020, 2030 are attached to one another, as shown in FIG. 20B, the two hanger portions 2052, 2054 come together to form the hanger 2050. As a result, when the hanger 2050 is received in a payload retriever, both the first clamping element 2020 and second clamping element 2030 are individually secured to the payload retriever. This configuration provides added reinforcement for supporting any payload held in the enclosure component 2010.

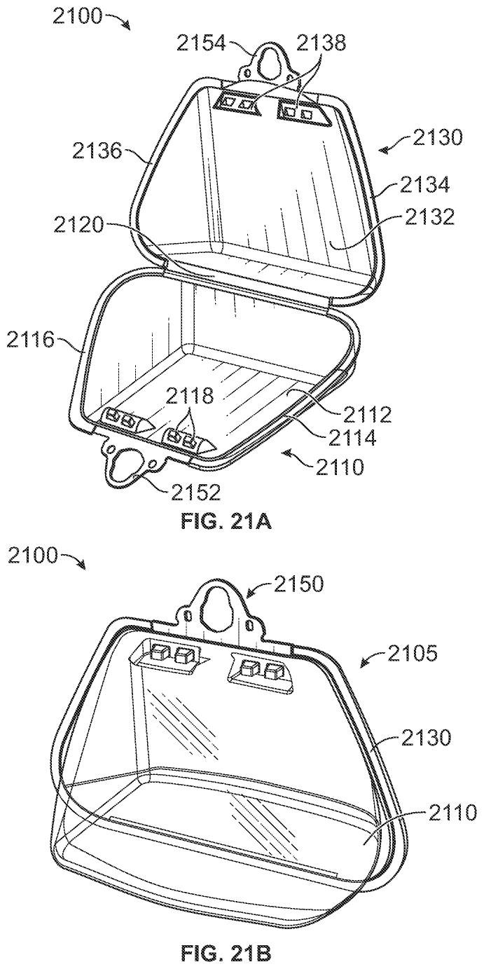

FIGS. 21A and 21B illustrate a package for transport and delivery by a UAV in accordance with another embodiment of the disclosure. As shown in FIG. 21B, package 2100 includes a container 2105 having a clamshell configuration that is formed by a first portion 2110 and a second portion 2130. As shown in FIG. 21A, the first portion 2110 has a concave shape including a concave interior side 2112, a convex exterior side 2114 and a first edge 2116 that extends around the perimeter of the first portion 2110. Similarly, the second portion 2130 also has a concave shape and includes a concave interior side 2132, a convex exterior side 2134 and a second edge 2136 that extends round the perimeter of the second portion 2130. The first and second portions 2110, 2130 are configured to attach to one another, as shown in FIG. 21B with the concave interior side 2112 of the first portion 2110 facing the concave interior side 2132 of the second portion 2130 so as to form an interior space between the two portions that is adapted to hold a payload.

When the package 2100 is in a closed position, as shown in FIG. 21B, the first edge 2116 of the first portion 2110 mates with the second edge 2136 of the second portion 2130 to enclose the interior space of the container 2105. In order to hold the first portion 2110 closed against the second portion 2130, the two portions of container 2105 include fastening structures that lock together. Specifically, as shown in FIG. 21A, first portion 2110 includes several fastening plugs 2118 and the second portion 2130 includes several receptacles 2138 that are configured to receive and hold the fastening plugs 2118 therein. In other embodiments, however, the edges of the opposing container portions may lock together when the container is closed. Further, in some embodiments separate clips or closures may be used to hold the container closed, as described in further detail below.

Package 2100 also includes a hanger 2150 attached to the container 2105 and configured for retrieving the package 2100 by a UAV. As shown in FIG. 21A, the hanger 2150 is formed of two portions including a first hanger portion 2152 that is attached to the first edge 2116 of the container 2105 and a second hanger portion 2154 that is attached to the second edge 2136 of the container 2105. As shown in FIG. 21B, when the container 2105 is closed, the two hanger portions come together to operate as a single hanger 2150.

The first portion 2110 and the second portion 2130 of package 2100 are attached to one another by a hinge 2120. The hinge 2120 keeps the first portion 2110 and the second portion 2130 secured to one another even when the package 2100 is open. Moreover, in view of the connection of the first portion 2110 and second portion 2130 through the hinge 2120, the package 2100 may be formed as a single integral piece. For example, package 2100 may be blow molded or otherwise formed of a single material formed in one piece. In other embodiments, however, the package may be formed of separate pieces, and the container itself may be formed of more than one piece.

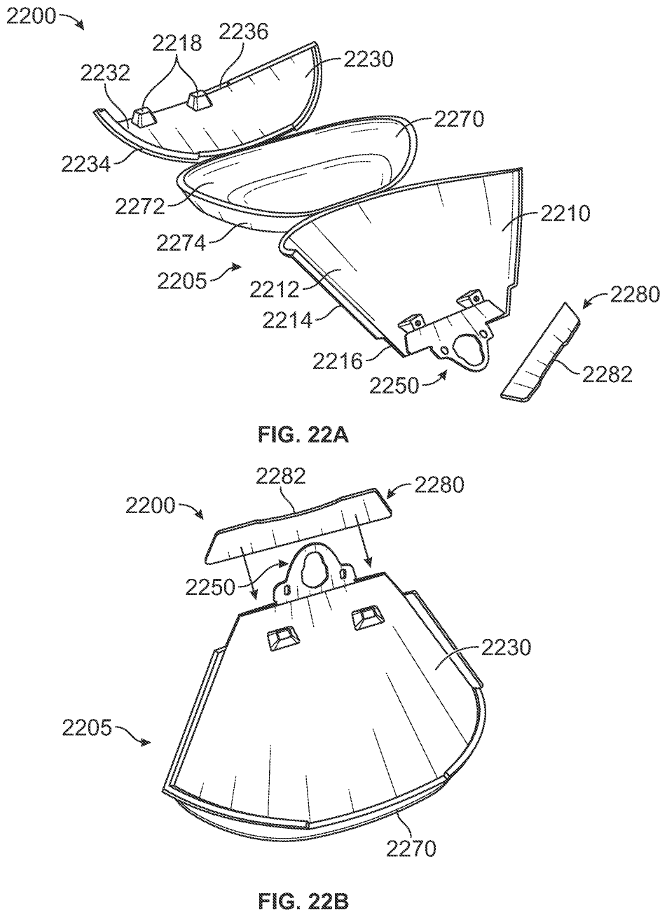

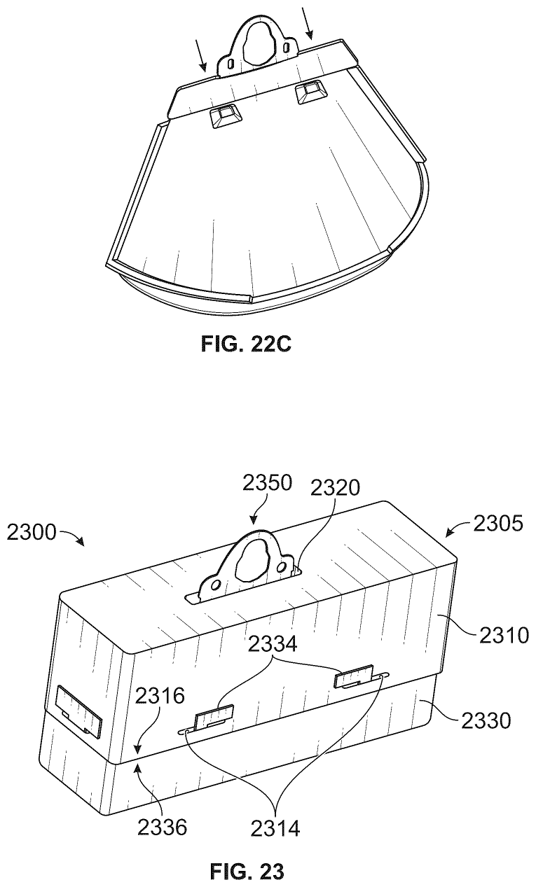

FIGS. 22A and 22B illustrate a package for transport and delivery by a UAV in accordance with another embodiment of the disclosure. As shown in FIG. 22A, package 2200 includes a container 2205 that is formed by a first portion 2210, a second portion 2230, and a third portion 2270. The first portion 2210 has a concave shape including a concave interior side 2212, a convex exterior side 2214 and a first edge 2216 that extends along the top of the first portion 2210. Similarly, the second portion 2230 also has a concave shape and includes a concave interior side 2232, a convex exterior side 2234 and a second edge 2236 that extends along the top of the second portion 2230. The third portion 2270 is positioned between the first portion 2210 and the second portion 2230 and includes a concave interior side 2272 and a convex exterior side 2274.

The third portion 2270 of the container 2205 is hingedly attached to each of the first portion 2210 and the second portion 2230 and forms the bottom of the container. To close the container 2205, as shown in FIG. 22B, the first and second portions 2210, 2230 are configured to attach to one another with the concave interior side 2212 of the first portion 2210 facing the concave interior side 2232 of the second portion 2230 so as to form an interior space between the three portions.

When the package 2200 is in a closed position, as shown in FIG. 22B, the first edge 2216 of the first portion 2210 mates with the second edge 2236 of the second portion 2230 to enclose the interior space of the container 2205. In order to hold the first portion 2210 closed against the second portion 2230, the two portions of container 2205 include fastening structures that lock together. Specifically, as shown in FIG. 22A, first portion 2210 includes several fastening plugs 2218 and the second portion 2230 includes several receptacles 2238 that are configured to receive and hold the fastening plugs 2218 therein.

Package 2200 also includes a hanger 2250 attached to the container 2205. As shown in FIG. 22A, the hanger 2250 is formed as a single piece that is secured to the first edge 2216 of the first portion 2210 of the container 2205. As explained above with respect to previously described embodiments, the hanger 2250 may be fixedly or removably attached to the container 2205.

Package 2200 also includes a cap 2280 that is configured to slip over the hanger 2250 and surround the upper parts of the first portion 2210 and second portion 2230 of the container, as shown in FIGS. 22B and 22C. The cap 2280 includes an aperture in the form of a slot 2282 that is adapted to receive the hanger 2250. When in place, the cap 2280 can help hold the opposing portions 2210, 2230 of the container together. Further the cap 2280 may be configured to only fit over the container 2205 if the container is properly closed. Accordingly, in addition to providing a secondary means of holding the container closed, the cap 2280 may also provide confirmation that the package is properly closed. As a result, a UAV may be able to determine whether a container is properly closed before retrieving the container.

FIG. 23 illustrates a package for transport and delivery by a UAV in accordance with another embodiment of the disclosure. Package 2300 includes a container 2305 having a clamshell configuration that is formed by a first portion 2310 and a second portion 2330. The first portion 2310 is formed as a lid having a concave shape and the second portion 2330 is formed as a vessel and also has a concave shape. To close the container 2305 a first edge 2316 of the lid 2310 mates with a second edge 2336 of the vessel 2330. To hold the container 2305 closed, the lid 2310 includes apertures 2314 and the vessel 2330 includes tabs 2334 that are configured to extend through the apertures 2314 of the lid. Of course, in other embodiments, the lid may include the tabs and the vessel may include the apertures that receive the tabs. Further, other locking mechanisms that hold the lid and vessel together are also possible.

Package 2300 also includes a hanger 2350 configured for retrieving the package by a UAV. In contrast to the previously described containers 2105 and 2205, the hanger 2350 of package 2300 extends through an aperture 2320 in the lid 2310. During flight, the load associated with a payload in the package is transferred from the vessel 2330 to the lid 2310, and from the lid 2310 to the hanger 2350.

While the two portions container 2305 (as well as the portions of containers 2105 and 2205) both have concave shapes, in other embodiments, one of the container portions may be flat. For example, in some embodiments, the container may include a flat lid and a concave vessel. Further, in some embodiments, the container may include a flat base that is covered by a domed lid. Further still, in some embodiments, the container may include a first side that is flat and a second side that is concave. It is also possible for one of the container portions to have a convex shape that fits into another of the container portions.

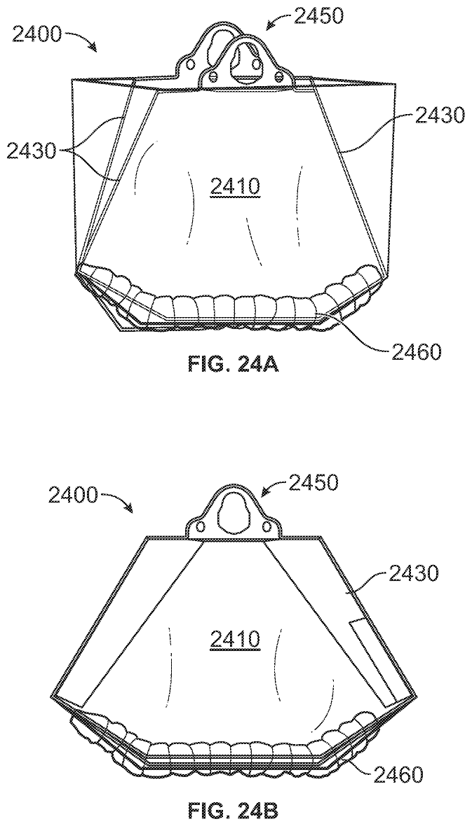

In some embodiments, the package may include an insulating layer, for example at the bottom of the package. Such an insulating layer may be included in an enclosure component, a structure component, a structural loop component, a container component or a container of the package. FIGS. 24A and 24B illustrate a package including such an insulation layer. Package 2400 includes a container component 2410 in the form of a bag and a hanger 2450 secured to the top of the bag 2410. The package 2400 also includes a structural loop component 2430 that extends from the hanger 2450 to the bottom of the bag 2410 to transfer loads from the bottom of the bag 2410 to the hanger 2450. Package 2400 also includes an insulating layer 2460 along the bottom of the bag 2410. The insulating layer 2460 is formed of a plurality of enclosed pockets that are integrally formed in the bottom of the bag.

The insulating layer 2460 may serve to protect the payload from damage if the package 2400 contacts an object during flight or when the package lands for delivery. Likewise, the insulating layer 2460 may also protect people or property if the package 2400 contacts them during flight or delivery. The insulating layer 2460 may also thermally insulate the payload during transport. For example, if the payload is a hot or cold food item, the insulating layer 2460 can help to limit heat transfer to or from the payload, thereby helping to maintain the temperature of the payload.

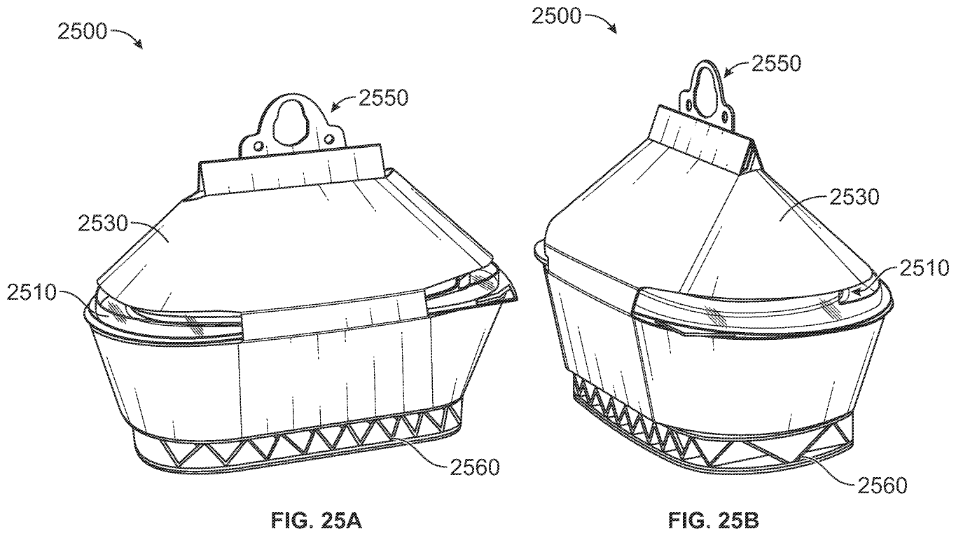

FIGS. 25A and 25B illustrate another package that includes such an insulating layer. Package 2500 includes a container component 2510 that is substantially enclosed within a structural loop component 2530 that also serves to form the aerodynamic outer shape of the package 2500. A hanger 2550 is secured to the structural loop component 2530 for carrying the package. An insulating layer 2560 is formed along the bottom of the structural loop component 2530. The insulating layer 2560 is formed of a corrugated sheet of cardboard. Similar to the insulating layer of package 2400, the insulating layer 2560 of package 2500 may provide both protection from impact as well as providing thermal insulation for the payload.

### VI. Conclusion

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A package adapted for use with an uncrewed aerial vehicle (UAV), the package comprising:
a hanger including:
a base, and
a handle extending up from the base, the handle including a handle opening and a bridge that extends over the handle opening, wherein the bridge is configured to be secured by a component of the UAV;
an enclosure component formed of a flexible first material and defining an enclosed interior space for holding a payload, the enclosure including a first side having an upper end attached to the base of the hanger and a lower end, a second side opposite the first side and having an upper end and a lower end, and a bottom extending from the lower end of the first side to a lower end of the second side; and
a first structure component formed of a second material and having a predetermined shape, the first structure component being secured to the enclosure component and defining at least a portion of a shape of the package.

2. The package of claim 1, wherein the first structure component is positioned adjacent to the bottom of the enclosure component.

3. The package of claim 2, wherein the first structure component is shaped to include at least two receptacles for holding objects.

4. The package of claim 1, wherein the first structure component surrounds the first side and the second side of the enclosure component.

5. The package of claim 4, further comprising a second structure component that is positioned adjacent to the bottom of the enclosure component.

6. The package of claim 1, further comprising an insulating layer adjacent to the bottom of the enclosure component.

7. The package of claim 1, wherein the hanger further includes holes configured to receive locking pins for holding the package, wherein the holes are disposed on opposing sides of the handle opening.

8. A package adapted for use with an uncrewed aerial vehicle (UAV), the package comprising:
a hanger including:
a base, and
a handle extending up from the base, the handle including a handle opening and a bridge that extends over the handle opening, wherein the bridge is configured to be secured by a component of the UAV;
a container component formed of a first material and defining a space for holding a payload; and
a structural loop component formed of a second material and including:
a first side having an upper end that is suspended from the base of the hanger and a lower end,
a second side opposite the first side and having an upper end and a lower end, and
a bottom extending from the lower end of the first side to a lower end of the second side, wherein the structural loop supports the container component.

9. The package of claim 8, wherein the container component is a bag formed of a flexible material.

10. The package of claim 8, wherein the container component includes a vessel having a predefined shape.

11. A package adapted for use with an uncrewed aerial vehicle (UAV), the package comprising:
a hanger including:
a base, and
a handle extending up from the base, the handle including a handle opening and a bridge that extends over the handle opening, wherein the bridge is configured to be secured by a component of the UAV;
an enclosure component formed of a flexible first material and defining an enclosed interior space for holding a payload, the enclosure including a first side having an upper end and a lower end, a second side opposite the first side and having an upper end and a lower end, and a bottom extending from the lower end of the first side to a lower end of the second side;
a first clamping element formed of a second material and fixedly attached to the base of the hanger; and
a second clamping element configured to cooperate with the first clamping element so as to hold a portion of the enclosure component between the first clamping element and the second clamping element.

12. The package of claim 11, wherein the first clamping element is hingedly attached to the second clamping element.

13. The package of claim 11, wherein the first clamping element includes a first locking component and the second clamping element includes a second locking component configured to couple to the first locking component.

14. The package of claim 11, wherein the hanger includes a first section attached to the first clamping element and a second section attached to the second clamping element.

15. A package adapted for use with an uncrewed aerial vehicle (UAV), the package comprising:
a container including:
a first portion having an interior side, an exterior side, and a first edge, and
a second portion having an interior side configured to face the interior side of the first portion so as to form an interior space for receiving a payload, an exterior side, and a second edge configured to mate with the first edge of the first portion so as to enclose the interior space; and
a hanger including:
a base secured to the first portion of the container, and
a handle extending up from the base, the handle including a handle opening and a bridge that extends over the handle opening, wherein the bridge is configured to be secured by a component of the UAV.

16. The package of claim 15, wherein the first portion of the container is hingedly attached to the second portion of the container.

17. The package of claim 15, wherein the container includes a third portion disposed between the first portion and the second portion.

18. The package of claim 15, wherein the first portion of the container is configured as a lid and the handle of the hanger extends through the lid.

19. The package of claim 15, further comprising a cap configured to extend around part of the first portion and second portion of the container so as to assist in holding the container closed.

20. The package of claim 19, wherein the cap includes an aperture configured to receive the hanger.
